(19) United States
(12) Patent Application Publication
(10) Pub. No.: US 2016/0363794 A1
(43) Pub. Date: Dec. 15, 2016

(54) Liquid Crystal Display Device and Method of Manufacturing the Same

(71) Applicants: BOE TECHNOLOGY GROUP CO., LTD., Beijing (CN); KENT STATE UNIVERSITY, Kent, OH (US)

(72) Inventors: Xiaochen ZHOU, Beijing (CN); Dengke YANG, Beijing (CN); Guangkui QIN, Beijing (CN)

(21) Appl. No.: 15/121,475

(22) PCT Filed: Nov. 20, 2015
(86) PCT No.: PCT/CN2015/095192

§ 371 Date: Aug. 25, 2016

(30) Foreign Application Priority Data
Nov. 20, 2014 (CN) 201410671019.9
Apr. 14, 2015 (CN) 201510175931.X

(51) Int. Cl. G02F 1/1334; C09K 19/54; G02F 1/1341

(52) U.S. Cl. CPC G02F 1/1334; G02F 1/1341; C09K 19/542; G02F 2001/13345; C09K 2019/546

(57) ABSTRACT

This invention discloses a liquid crystal display (LCD) device and a method of manufacturing the same. The LCD device comprises a first substrate and a second substrate opposing each other, and a nematic liquid crystal layer disposed therebetween and comprising a nematic liquid crystal and a polymer network. The polymer network is formed by irradiation polymerization of a functional monomer in a nematic liquid crystal mixture. The polymer network can reduce the scattering phenomena caused by the refractive index mismatch between liquid crystal and polymer in the prior LCD devices and significantly reduce the dark-state light leakage, so that the contrast is improved. Moreover, since there is no polymer projection disposed on the alignment layer according to the invention, the dark-state light leakage caused by polymer projections is avoided and thus the contrast is further improved.

### TECHNICAL FIELD

This invention relates to the field of display technology, and particularly, to a liquid crystal display device and a method of manufacturing the same.

### BACKGROUND ART

Currently, liquid crystal display (LCD) devices are widely used in displays, smart phones, televisions and other commercial products due to the advantages of low power consumption, light weight and thin thickness. However, the LCD devices also have shortcomings of limited viewing angle and slow response speed of liquid crystal. In order to overcome the above problems existed in the LCD devices, multi-domain vertical alignment technology or polymer-stabilized alignment technology is usually adopted in the LCD devices of the prior art, such that the LCD devices with broad viewing angle can be achieved and the response speed of liquid crystal in the LCD devices can be increased.

Typically, polymer projections are formed on alignment layers of the LCD devices. The polymer projections can allow the liquid crystal molecules to pretilt. However, dark-state light leakage may be caused by the refractive index mismatch between the liquid crystal and the polymer, as well as by the alignment difference between the areas around the polymer projections and the areas free of the polymer projections. Consequently, the contrast is decreased.

### SUMMARY

An object of the present invention is to provide a LCD device and a method of manufacturing the device for improvement in contrast.

To achieve the above object, the present invention provides a LCD device comprising a first substrate and a second substrate opposing each other, and a nematic liquid crystal layer disposed between the first substrate and the second substrate, wherein the nematic liquid crystal layer comprises a nematic liquid crystal and a polymer network, and wherein the polymer network is formed by irradiation polymerization of a functional monomer in a nematic liquid crystal mixture comprising the nematic liquid crystal and the functional monomer.

Preferably, the functional monomer comprises, at an end of its molecule, a linear aliphatic chain having a terminal ester group.

Preferably, the functional monomer comprises, in the middle of its molecule, a divalent phenylene or biphenylene group having a hydrocarbyl or halogen substituent, and at least one methylene group.

Preferably, the functional monomer comprises at least one divalent phenylene or biphenylene group, and a terminal (meth)acrylate group linked thereto via a divalent alkylene group, wherein the divalent phenylene or biphenylene group optionally has one or more hydrocarbyl or halogen substituent(s).

Preferably, the functional monomer is represented by the following chemical formula:

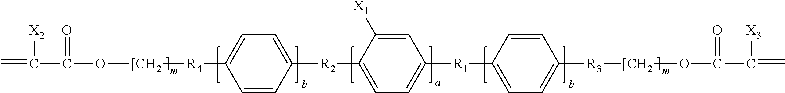

wherein a and each b are independently an integer from 0 to 5; each m is independently an integer from 0 to 15; X₁, X₂ and X₃ are each independently a hydrogen atom, halogen., or methyl; R₁, R₂, R₃ and R₄ are each independently an oxygen atom, ester group, or methylene group, provided that (i) a and b are not both zero, and (ii) when R₃ or R₄ is an oxygen atom or ester group, the subscript in of —CH₂— linked thereto is not zero.

Preferably, the functional monomer is a photosensitive monomer, and the nematic liquid crystal mixture further comprises a photoinitiator; and

the polymer network is formed by polymerization reaction of the photosensitive monomer and the photoinitiator under ultraviolet (UV) irradiation.

Preferably, the concentration of the photosensitive monomer in the nematic liquid crystal mixture ranges from 0.01 wt % to 15 wt %.

Preferably, the concentration of the photoinitiator in the nematic liquid crystal mixture ranges from 0.001 wt % to 2 wt %.

Preferably, the functional monomer has a functionality of greater than 1.

Preferably, the LCD device includes Advanced Super Dimension Switch (ADS) LCD devices.

Preferably, the first substrate and the second substrate each comprise an alignment layer without any polymer projection disposed thereon.

To achieve the aforesaid object, the present invention also provides a method of manufacturing a LCD device, including the following steps:

disposing a nematic liquid crystal mixture between a first substrate and a second substrate opposing each other, wherein the nematic liquid crystal mixture comprises a nematic liquid crystal and a functional monomer; and

irradiating the functional monomer to polymerize it into a polymer network, such that a nematic liquid crystal layer is formed from the nematic liquid crystal mixture, wherein the nematic liquid crystal layer comprises the nematic liquid crystal and the polymer network.

Preferably, the step of irradiating the functional monomer to polymerize it into a polymer network comprises:

irradiating the functional monomer with UV light to form the polymer network.

Preferably, the functional monomer is a photosensitive monomer, and the nematic liquid crystal mixture further comprises a photoinitiator; and

the irradiating the functional monomer with UV light to form the polymer network comprises: irradiating the photosensitive monomer and the photoinitiator with UV light to polymerize into a polymer network.

The present invention has the following advantageous effects.

In the LCD device and the method of manufacturing the device according to the present invention, a nematic liquid crystal layer is disposed between the first substrate and the second substrate, wherein the nematic liquid crystal layer comprises a nematic liquid crystal and a polymer network, and wherein the polymer network is formed by irradiation polymerization of a functional monomer in a nematic liquid crystal mixture. The polymer network can reduce the scattering phenomena caused by the refractive index mismatch between liquid crystal and polymer in the prior LCD devices and significantly reduce the dark-state light leakage, so that the contrast is improved. Moreover, since there is no polymer projection disposed on the alignment layer according to the present invention, the dark-state light leakage caused by polymer projections is avoided and thus the contrast is further improved.

### BRIEF DESCRIPTION OF THE DRAWINGS

FIG. 1 is a schematic structure diagram showing a LCD device according to an exemplary embodiment of the present invention;

FIG. 2 is a schematic plan view of the nematic liquid crystal layer of FIG. 1;

FIG. 3 is a schematic diagram showing formation of a polymer network;

FIG. 4 is a flowchart showing a process of manufacturing a LCD device according to an exemplary embodiment of the present invention.

### DETAILED DESCRIPTION OF CERTAIN EMBODIMENTS

To enable a person skilled in the art to better understand the technical solution of the present invention, the LCD device and its manufacturing method according to the invention will be further described in detail with reference to the drawings.

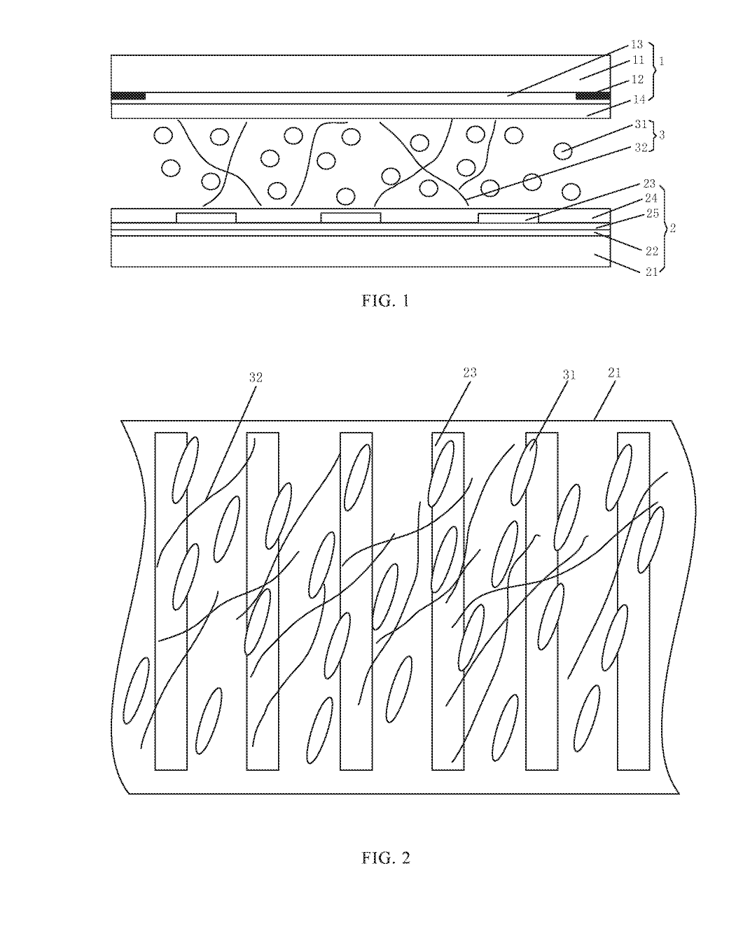

FIG. 1 is a schematic structure diagram of a LCD device according to an exemplary embodiment of the present invention, and FIG. 2 is a schematic plan view of the nematic liquid crystal layer of FIG. 1. As shown in FIGS. 1 and 2, the LCD device comprises a first substrate 1 and a second substrate 2 opposing each other, and a nematic liquid crystal layer 3 disposed between the first substrate 1 and the second substrate 2, wherein the nematic liquid crystal layer 3 comprises a nematic crystal 31 and a polymer network 32.

The LCD device of this exemplary embodiment is an ADS LCD device. The first substrate 1 is a color filter substrate, and the second substrate 2 is an array substrate. Specifically, the first substrate 1 may comprise a first base substrate 11, a black matrix 12, a color matrix pattern 13 and a first alignment layer 14. The black matrix 12 is formed on the first base substrate 11. The color matrix pattern 13 is positioned on the first base substrate 11 and covers the spaces between the black matrix 12. The first alignment layer 14 is positioned on the color matrix pattern 13. Specifically, the second substrate 2 comprises a second base substrate 21, a common electrode 22, pixel electrodes 23 and a second alignment layer 24. The common electrode 22 is positioned on the second base substrate 21, the pixel electrodes 23 are disposed above the common electrode 22, and the second alignment layer 24 is positioned on the pixel electrodes 23. An insulation layer 25 is formed on the common electrode 22, such that the pixel electrodes 23 are positioned on the insulation layer 25, and the second alignment layer 24 covers the insulation layer 25. Among others, the pixel electrodes 23 may be strip electrodes. The alignment direction of the second alignment layer 24 may or may not be parallel to the alignment direction of the first alignment layer 14. The second substrate further comprises gate lines, data lines, thin film transistors, etc. (not shown in FIG. 1). Compared to Twist Nematic (TN) LCD devices or Vertical Alignment (VA) LCD devices, the ADS LCD devices have the advantage of broad viewing angle. Therefore, the LCD device is preferably an ADS LCD device.

The polymer network 32 locates among the nematic liquid crystal 31 and can provide strong alignment anchoring effect which tends to stabilize the nematic liquid crystal 31. The polymer network 32 is crosslinked.

As shown in FIG. 2, both the nematic liquid crystal 31 and the polymer network 32 are aligned along the alignment direction. When an external voltage is applied to the LCD device, an electric field is generated between the common electrode 22 and the pixel electrodes 23, which may drive the nematic liquid crystal 31 to rotate. However, the polymer network 32 keeps its original position and does not move due to its size and high crosslinking density. When the external voltage applied to the LCD device is removed, the nematic liquid crystal 31 rotates back quickly according to the anchoring of the polymer network 32. On the other hand, since the polymer network 32 improves the surface alignment effect of the LCD device, it is difficult to drive the nematic liquid crystal 31 to rotate from an initial orientation and thus the driving voltage should be increased after formation of the polymer network 32. During the rise time period immediately upon applying an external voltage, the driving voltage will also increase to accelerate the rise time period.

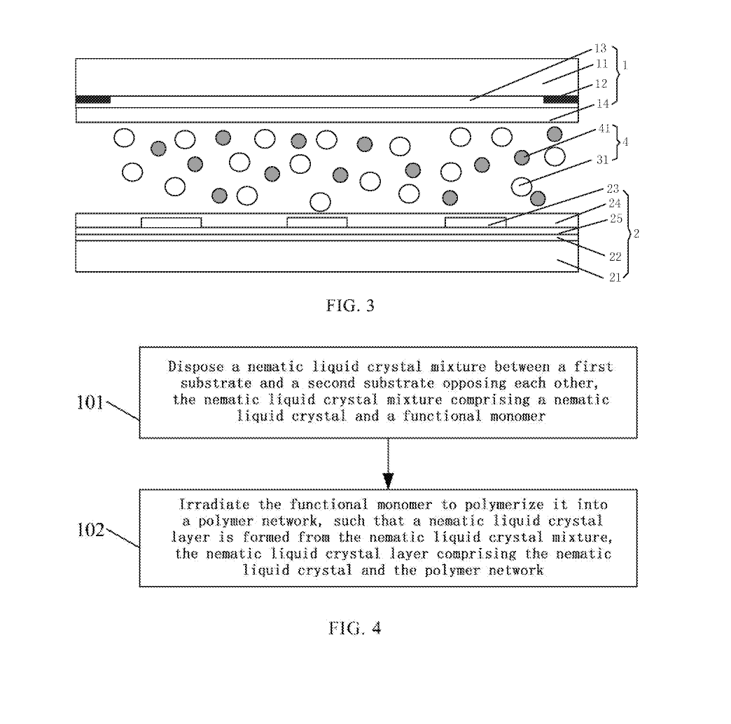

FIG. 3 is a schematic diagram of formation of a polymer network. The polymer network 32 as shown in FIGS. 1 and 2 is formed by irradiation polymerization of a functional monomer 41 in a nematic liquid crystal mixture 4 comprising the nematic liquid crystal 31 and the functional monomer 41.

Herein, the term “functional monomer” refers to a monomer comprising a reactive functional group or groups which allow the functional monomer to be polymerized into a polymer network when it is subjected to irradiation (e.g., UV light or electron beam irradiation). The functional monomer is particularly a bifunctional liquid crystal monomer material having both the properties of a liquid crystal monomer and the polymerizable property, which is also referred to as “bifunctional monomer”. Examples of the bifunctional monomer include, but are not limited to, RM257 (1,4-bis-[4-(3-acryloyloxypropyloxy)benzoyloxy]-2-methylbenzene), and HNGOO9 available from Jiangsu Synthesis Company. Any monomers having similar functions as described above may be used in the present invention. The term “functionality” refers to the number of the reactive functional group per functional monomer.

Specifically, the functional monomer 41 may be polymerized under irradiation to form the polymer network 32. The nematic liquid crystal mixture 4 is disposed between the first alignment layer 14 and the second alignment layer 24. .Preferably, the chemical structure of the functional monomer 41 has a rod-like structure similar to the nematic liquid crystal 31, such that the functional monomer 41 can be well dissolved in the nematic liquid crystal 31. The functional monomer 41 is also in a nematic phase and is aligned along the alignment direction just like the nematic liquid crystal 31. The LCD device as shown in HG. 3 is placed under a UV lamp to initiate polymerization of the functional monomer 41 by irradiation of the UV lamp. When a UV lamp is used to irradiate the LCD device as shown in FIG. 3, it is allowable for the UV lamp to irradiate the nematic liquid crystal mixture 4 from the first base substrate 11 side, from the second base substrate 21 side, or both. In the process of polymerization, the functional monomer 41 is polymerized and separates from the nematic liquid crystal mixture 4 to form the polymer network 32. The orientation of the resultant polymer network 32 corresponds to the orientation of the nematic liquid crystal 31. The structure of the polymer network 32 may depend on the formula and the concentration of the functional monomer 41, as well as the processing conditions. After polymerization, the polymer network 32 can stabilize the nematic liquid crystal 31 at the positions where the polymer has been formed. As the polymer is crosslinked within the whole LCD device, the nematic liquid crystal 31 orientates along the long axis of the polymer network. Thus, when the driving voltage is shut off, the nematic liquid crystal 31 can restore to its original state more quickly, thereby improving the response speed.

Preferably, the molecule of the functional monomer 41 is rod-like, which has a rigid core and a flexible tail.

Preferably, the functional monomer 41 is a photosensitive monomer. In this case, the nematic liquid crystal mixture 4 may further comprise a photoinitiator, and the polymer network 32 is formed by polymerization of the photosensitive monomer 41 and the photoinitiator under UV irradiation. Preferably, the concentration of the photosensitive monomer (or functional monomer) in the nematic liquid crystal mixture 4 ranges from 0.01 wt % to 15 wt %, for example, 0.01 wt %, 0.05 wt %, 0.1 wt %, 0.5 wt %, 1 wt %, 2.5 wt %, 5 wt %, 7.5 wt %, 10 wt %, 12.5 wt %, or 15 wt %. The concentration of the photoinitiator in the nematic liquid crystal mixture 4 may range from 0.001 wt % to 2 wt %, for example, 0.001 wt %, 0.005 wt %, 0.01 wt %, 0.05 wt %, 0.1 wt %, 0.5 wt %, 1 wt %, 1.25 wt %, 1.5 wt %, 1.75 wt %, or 2 wt %, depending on the amount of the photosensitive monomer. The species of the photoinitiator and the nematic liquid crystal are not particularly limited, and those commonly used in the art may be useful in the present invention.

When the LCD device is in a dark state, the refractive index difference between the nematic liquid crystal 31 and the polymer network 32 causes the only scattering. Thus, in order to reduce the scattering effect of the LCD device and maintain a high contrast, it is particularly important to select the functional monomer 41 having an appropriate formula. For example, the refractive index difference between the nematic liquid crystal and the polymer network may he within ±0.3, and preferably within ±0.2. Preferably, the functional monomer 41 comprises, at an end of its molecule, a linear aliphatic chain having a terminal ester group (e.g., terminal (meth)acrylate group). Preferably, the functional monomer 41 comprises, in the middle of its molecule, a divalent phenylene or biphenylene group having a hydrocarbyl or halogen substituent, and at least one methylene group. Preferably, the functional monomer 41 comprises at least one divalent phenylene or biphenylene group, and a terminal (meth)acrylate group linked thereto via a divalent alkylene group, wherein the divalent phenylene or biphenylene group optionally has one or more hydrocarbyl or halogen substituen s).

Herein, the term “(meth)acrylate” includes both acrylates and methacrylates, and the (meth)acrylate may optionally be substituted with halogen. The term “halogen” includes fluorine, chlorine, bromine, and iodine. The term “biphenylene” refers to two or more (e.g., 2 to 5) non-fused benzene rings linked one by one via a covalent bond. The term “hydrocarbyl” includes linear or branched, saturated or unsaturated aliphatic hydrocarbyl groups and aromatic hydrocarbyl groups, preferably an aliphatic hydrocarbyl group, more preferably a linear or branched alkyl group, and most preferably a linear or branched C1-C6 alkyl group.

For example, the functional monomer 41 may be represented by the following chemical formula:

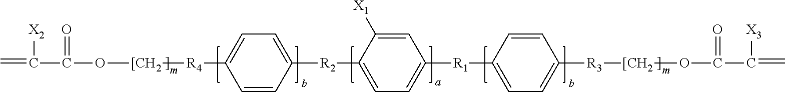

wherein a and each b are independently an integer from 0 to 5; each m is independently an integer from 0 to 15; X₁, X₂ and X₃ are each independently a hydrogen atom, halogen, or methyl; R₁, R₂, R₃ and R₄ are each independently an oxygen atom, ester group, or methylene group, provided that (i) a and b are not both zero, and (ii) when R₃ or R₄ is an oxygen atom or ester group, the subscript m of —CH₂— linked thereto is not zero.

Preferably, the functional monomer has a functionality of greater than 1, for example, 2, 3, 4, etc.

In the LCD device of this exemplary embodiment, a nematic liquid crystal layer is disposed between the first substrate and the second substrate, wherein the nematic liquid crystal layer comprises a nematic liquid crystal and a polymer network, and wherein the polymer network is formed by irradiation polymerization of a functional monomer in a nematic liquid crystal mixture. The polymer network can reduce the scattering phenomena caused by the refractive index mismatch between liquid crystal and polymer in the prior LCD devices and significantly reduce the dark-state light leakage, so that the contrast is improved. Moreover, since there is no polymer projection disposed on the alignment layer according to the embodiment, the dark-state light leakage caused by polymer projections is avoided and thus the contrast is further improved. Also, the polymer network disposed in the nematic liquid crystal layer increases the response speed of the LCD device.

FIG. 4 is a flowchart showing a process of manufacturing a LCD device according to an exemplary embodiment of the present invention. The process comprises steps 101 and 102, as shown in FIG. 4.

In the step 101, a nematic liquid crystal mixture is disposed between a first substrate and a second substrate opposing each other, wherein the nematic Uquid crystal mixture comprises a nematic liquid crystal and a functional monomer.

The first substrate and the second substrate are as shown in FIG. 3. The first substrate 1 is a color filter substrate, and the second substrate 2 is an array substrate. More details about the first and second substrates 1, 2 are as described above in the preceding embodiment. In the step 101, the first and second substrates 1, 2 are prepared and then arranged oppositely, followed by filling the nematic liquid crystal mixture 4 between them. More details about the nematic liquid crystal mixture 4 are as described above in the preceding embodiment.

In the step 102, the functional monomer is polymerized under irradiation to form a polymer network, such that a nematic liquid crystal layer is formed from the nematic liquid crystal mixture, wherein the nematic liquid crystal layer comprises the nematic liquid crystal and the polymer network.

As shown in FIGS. 1 and 3, the step 102 may particularly comprise irradiating the functional monomer 41 with UV light to form the polymer network 32.

In the case of irradiating the functional monomer 41 with UV light to form the polymer network 32, the functional monomer 41 is a photosensitive monomer, and the nematic liquid crystal mixture 4 may further comprise a photoinitiator. Thus, the operation of irradiating the functional monomer 41 with UV light to form the polymer network 32 comprises: irradiating the photosensitive monomer and the photoinitiator with UV light to polymerize into the polymer network 32.

In practical applications, a LCD device as shown in FIG. 3 may be placed under a UV lamp to initiate polymerization of the functional monomer 41 by irradiation of the UV lamp. When a UV lamp is used to irradiate the LCD device as shown in FIG. 3, it is allowable for the UV lamp to irradiate the nematic liquid crystal mixture 4 from the first base substrate 11 side, from the second base substrate 21 side, or both. In the process of polymerization, the functional monomer 41 is polymerized and separates from the nematic liquid crystal mixture 4 to form the polymer network 32. The polymer network 32 replicates the structure of the nematic liquid crystal 31 during polymerization.

In the method of manufacturing the LCD device of this exemplary embodiment, a nematic liquid crystal layer is disposed between the first substrate and the second substrate, wherein the nematic liquid crystal layer comprises a nematic liquid crystal and a polymer network, and wherein the polymer network is formed by irradiation polymerization of a functional monomer in a nematic liquid crystal mixture. The polymer network can reduce the scattering phenomena caused by the refractive index mismatch between liquid crystal and polymer in the prior LCD devices and significantly reduce the dark-state light leakage, so that the contrast is improved. Moreover, since there is no polymer projection disposed on the alignment layer according to the embodiment, the dark-state light leakage caused by polymer projections is avoided and thus the contrast is further improved. Also, the polymer network disposed in the nematic liquid crystal layer increases the response speed of the LCD device.

As used in this specification and the appended claims, the singular forms “a”, “an”, and “the” include plural referents unless the content clearly dictates otherwise. The term “or” is generally employed in its sense including “and/or” unless the content clearly indicates otherwise. The words “comprise”, “have”, “include”, “contain”, and variants thereof are each in an open mode and do not exclude additional, unrecited elements or process steps.

All numbers herein are to be understood as being modified in all instances by the term “about”. The recitation of numerical ranges by endpoints includes all subsets and numbers subsumed within that range (e.g., 0 to 5 includes 0, 1, 2, 3, 4 and 5).

### EXAMLPES

The materials of each example listed in the table below were weighed in the given proportions (wt %), and mixed together (Bifunctional monomer: RM257 (1,4-bis-[4-(3-acryloyloxypropyloxy)benzoyloxy]-2-methylbenzene); MAT-11-575: a nematic liquid crystal available from Merk Co.; Initiator: photoinitiator BME available from Merk Co.). Each mixture was heated until all solids were completely melted into a liquid, under vibration or ultrasonic agitation. Each sample of the examples was prepared by filling the resultant liquid crystal mixture, confirming by observation under a microscope, and then curing under UV irradiation by a light source available from Melles Griot Co. (λ=543 nm).

Each sample of the examples was tested according to the following test procedures, and the results are reported in the table below.

Response time and contrast: tested according to the standard method set forth in Chinese National Standard GRIT 18910.61-2012, Sections 5.3 and 5.5 of Part 6-1. It is noted that the response time as measured is the sum of rise time and fall time.

Refractive index: measured by Abbe refractive index meter.

| | | | | | | | Evaluation | | |
|---|---|---|---|---|---|---|---|---|---|
| | | | | | | | Refractive | | |
| | | | | | | | index | | |
| | | | | | | | difference | | |
| | | | | Photoinitiator | | Nematic | between | | |
| | Functional monomer | | | | Irradiation | liquid | liquid crystal | | Response |
| No. | Type | Conc. | Functionality | Conc. | condition | crystal | and polymer | Contrast | time |
| Ex 1 | Bifunctional | 1% | 2 | 0.1% | 5 mw/cm² | MAT-11- | 0-0.3 | 718 | 13 ms |
| | monomer | | | | | 575 | | | |
| Ex 2 | Bifunctional | 3% | 2 | 0.3% | 5 mw/cm² | MAT-11- | 0-0.3 | 552 | 14 ms |
| | monomer | | | | | 575 | | | |
| Ex 3 | Bifunctional | 4% | 2 | 0.4% | 5 mw/cm² | MAT-11- | 0-0.3 | 526 | 9 ms |
| | monomer | | | | | 575 | | | |
| Ex 4 | Bifunctional | 5% | 2 | 0.5% | 5 mw/cm² | MAT-11- | 0-0.3 | 404 | 7 ms |
| | monomer | | | | | 575 | | | |

As shown by the results, the present invention can reduce the scattering phenomena caused by the refractive index mismatch between liquid crystal and polymer in the prior LCD devices and significantly reduce the dark-state light leakage, by introducing a polymer network in the nematic liquid crystal layer. Moreover, since there is no polymer projection disposed on the alignment layer according to the present invention, the dark-state light leakage caused by polymer projections is avoided. Therefore, the contrast is significantly improved according to the present invention. Also, the polymer network disposed in the nematic liquid crystal layer according to the present invention increases the response speed of the LCD device. Similar results were obtained when the bifunctional monomer RM257 used in Examples 1-4 were replaced by HNG009 available from Jiangsu Synthesis Company. In addition, with increasing of the concentration (e.g., 15%) of the bifunctional monomer, the display device achieved a higher response speed, while the contrast exhibited a certain decrease.

It is understood that the above embodiments are merely exemplary embodiments employed to illustrate the principles of the present invention, and the invention is not limited thereto. Those of ordinary skill in the art may make various modifications and improvements without departing from the spirit and essence of the present invention, and such modifications and improvements are also encompassed in the scope of the invention.

1. A liquid crystal display device, comprising: a first substrate and a second substrate opposing each other, and a nematic liquid crystal layer disposed between the first substrate and the second substrate, wherein the nematic liquid crystal layer comprises a nematic liquid crystal and a polymer network, and wherein the polymer network is formed by irradiation polymerization of a functional monomer in a nematic liquid crystal mixture comprising the nematic liquid crystal and the functional monomer.

2. The liquid crystal display device according to claim 1, wherein the functional monomer comprises, at an end of its olecule, a linear aliphatic chain having a terminal ester group.

3. The liquid crystal display device according to claim 1, wherein the functional monomer comprises, in the middle of its molecule, a divalent phenylene or biphenylene group having a hydrocarbyl or halogen substituent, and at least one methylene group.

4. The liquid crystal display device according to claim 1, wherein the functional monomer comprises at least one divalent phenylene or biphenylene group, and a terminal (meth)acrylate group linked thereto via a divalent alkylene group, wherein the divalent phenylene or biphenylene group optionally has one or more hydrocarbyl or halogen substituent(s).

5. The liquid crystal display device according to claim 4, wherein the functional monomer is represented by the following chemical formula: 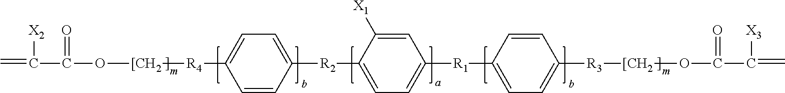
wherein a and each b are independently an integer from 0 to 5; each m is independently an integer from 0 to 15; X₁, X₂ and X₃ are each independently a hydrogen atom, halogen, or methyl; R₁, R₂, R₃ and R₄ are each independently an oxygen atom, ester group, or methylene group, provided that (i) a and b are not both zero, and (ii) when R₃ or R₄ is an oxygen atom or ester group, the subscript in of —CH₂— linked thereto is not zero.

6. The liquid crystal display device according to claim 1, wherein the functional monomer is a photosensitive monomer, and the nematic liquid crystal mixture further comprises a photoinitiator; and
the polymer network is formed by polymerization of the photosensitive monomer and the photoinitiator under ultraviolet irradiation.

7. The liquid crystal display device according to claim 6, wherein the concentration of the photosensitive monomer in the nematic liquid crystal mixture ranges from 0.01 wt % to 15 wt %.

8. The liquid crystal display device according to claim 6, wherein the concentration of the photoinitiator in the nematic liquid crystal mixture ranges from 0.001 wt % to 2 wt %.

9. The liquid crystal display device according to claim 1, wherein the functional monomer has a functionality of greater than 1.

10. The liquid crystal display device according to claim 1, wherein the liquid crystal display device includes Advanced Super Dimension Switch liquid crystal display devices.

11. The liquid crystal display device according to claim 1, wherein the first substrate and the second substrate each comprise an alignment layer without any polymer projection disposed thereon.

12. A method of manufacturing a liquid crystal display device, comprising the following steps:
disposing a nematic liquid crystal mixture between a first substrate and a second substrate opposing each other, wherein the nematic liquid crystal mixture comprises a nematic liquid crystal and a functional monomer; and
irradiating the functional monomer to polymerize it into a polymer network, such that a nematic liquid crystal layer is formed from the nematic liquid crystal mixture, wherein the nematic liquid crystal layer comprises the nematic liquid crystal and the polymer network.

13. The method of manufacturing a liquid crystal display device according to claim 12, wherein the step of irradiating the functional monomer to polymerize it into a polymer network comprises:
irradiating the functional monomer with ultraviolet light to form the polymer network.

14. The method of manufacturing a liquid crystal display device according to claim 13, wherein the functional monomer is a photosensitive monomer, and the nematic liquid crystal mixture further comprises a photoinitiator; and
the irradiating the functional monomer with ultraviolet light to form the polymer network comprises: irradiating the photosensitive monomer and the photoinitiator with the ultraviolet light to polymerize into the polymer network.
